(19) United States
(12) Patent Application Publication
(10) Pub. No.: US 2010/0278058 A1
(43) Pub. Date: Nov. 4, 2010

(54) METHOD AND APPARATUS FOR FACILITATING MULTICARRIER DIFFERENTIAL CHANNEL QUALITY INDICATOR (CQI) FEEDBACK

(75) Inventors: Jelena M. Damnjanovic, Del Mar, CA (US); Juan Montojo, San Diego, CA (US); Avneesh Agrawal, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/640,382

(22) Filed: Dec. 17, 2009

Related U.S. Application Data
(60) Provisional application No. 61/175,392, filed on May 4, 2009.

(51) Int. Cl. H04B 17/00; H04J 1/16; H04B 7/00

(52) U.S. Cl. 370/252; 455/507; 455/67.11; 375/224

(57) ABSTRACT

Methods, apparatuses, and computer program products are disclosed for facilitating multicarrier channel quality indicator (CQI) feedback. A wireless terminal communicates with a base station via a plurality of carriers and receives configuration data generated by the base station identifying a subset of carriers included in the plurality of carriers. The wireless terminal identifies a reference carrier and reports a reference CQI value corresponding to the reference carrier to the base station. The wireless terminal also reports a differential CQI value derived from the reference CQI value to the base station.

### CROSS-REFERENCE TO RELATED APPLICATIONS

This application claims the benefit of U.S. Provisional Patent application Ser. No. 61/175,392 entitled “MULTICARRIER DIFFERENTIAL CHANNEL QUALITY INDICATOR (CQI) FEEDBACK FOR ADVANCED LONG TERM REVOLUTION (LTE) SYSTEM,” which was filed May 4, 2009. The entirety of the aforementioned application is herein incorporated by reference.

### BACKGROUND

I. Field

The following description relates generally to wireless communications, and more particularly to methods and apparatuses for facilitating multicarrier CQI feedback.

II. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

In designing a reliable wireless communication system, special attention must be given to particular data transmission parameters. For instance, with respect to a multicarrier communication, it would be desirable to know the signal quality of particular carriers that facilitate such communication. However, the bandwidth costs of providing a channel quality indicator (CQI) for each carrier rapidly become unacceptable as the number of desired CQIs increases. Accordingly, it would be desirable to develop a method and apparatus for efficiently providing multicarrier CQI feedback.

The above-described deficiencies of current wireless communication systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating multicarrier channel quality indicator (CQI) feedback. In one aspect, methods, apparatuses, and computer program products are disclosed for facilitating multicarrier CQI feedback from a wireless terminal. Within such embodiment, the wireless terminal communicates with a base station via a plurality of carriers. A configuration dataset is received from the base station and identifies a subset of carriers included in the plurality of carriers. The wireless terminal identifies a reference carrier within the subset of carriers according to instructions provided in the configuration dataset. The wireless terminal also reports a reference CQI value and at least one differential CQI value to the base station. The reference CQI value corresponds to the reference carrier, whereas the at least one differential CQI value is derived from the reference CQI value.

In a further aspect, another apparatus for facilitating multicarrier CQI feedback from a wireless terminal is disclosed. Within such embodiment, a means for communicating with a base station via a plurality of carriers is provided. The apparatus also includes a means for receiving a configuration dataset from the base station such that the configuration dataset identifies a subset of carriers included in the plurality of carriers. Means for identifying a reference carrier within the subset of carriers are also provided according to instructions provided in the configuration dataset. The apparatus further includes means for reporting a reference CQI value and at least one differential CQI value to the base station. The reference CQI value corresponds to the reference carrier, whereas the at least one differential CQI value is derived from the reference CQI value.

In another aspect, methods, apparatuses, and computer program products are disclosed for facilitating multicarrier CQI feedback from a base station. Within such embodiment, the base station communicates with a wireless terminal via a plurality of carriers. A configuration dataset is generated by the base station and identifies a subset of carriers included in the plurality of carriers. The base station transmits the configuration dataset to the wireless terminal, and processes CQI data received from the wireless terminal. The CQI data includes a reference CQI value and at least one differential CQI value. The reference CQI value corresponds to a reference carrier for the subset of carriers, whereas the at least one differential CQI value is derived from the reference CQI value.

In a further aspect, another apparatus for facilitating multicarrier CQI feedback from a base station is disclosed. Within such embodiment, the apparatus includes means for communicating with a wireless terminal via a plurality of carriers and means for generating a configuration dataset for identifying a subset of carriers included in the plurality of carriers. A means for transmitting the configuration dataset to the wireless terminal is also provided, as well as a means for processing a CQI data received from the wireless terminal. The received CQI data includes a reference CQI value and at least one differential CQI value. The reference CQI value corresponds to a reference carrier for the subset of carriers, whereas the at least one differential CQI value is derived from the reference CQI value.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example wireless network environment that can be employed in conjunction with the various systems and methods described herein.

FIG. 3 illustrates an exemplary system for facilitating multicarrier CQI feedback in accordance with some aspects.

FIG. 4 illustrates a block diagram of an exemplary wireless terminal that facilitates multicarrier CQI feedback in accordance with an aspect of the subject specification.

FIG. 5 is an illustration of an exemplary coupling of electrical components that effectuate facilitating multicarrier CQI feedback from a wireless terminal.

FIG. 6 is an exemplary mapping of carrier differential CQI offset levels to carrier differential CQI values in accordance with an aspect of the subject specification.

FIG. 7 is a flow chart illustrating an exemplary methodology for facilitating multicarrier CQI feedback via reference carriers selected as a function of CQI value.

FIG. 8 is a diagram illustrating an exemplary scheme for reporting differential sub-band CQI values in accordance with some aspects.

FIG. 9 is a diagram illustrating an exemplary scheme for reporting differential values with respect to a wideband CQI value in accordance with some aspects.

FIG. 10 is a flow chart illustrating an exemplary methodology for facilitating multicarrier CQI feedback via predetermined reference carriers.

FIG. 11 illustrates a block diagram of an exemplary base station that facilitates multicarrier CQI feedback in accordance with an aspect of the subject specification.

FIG. 12 is an illustration of an exemplary coupling of electrical components that effectuate facilitating multicarrier CQI feedback from a base station.

FIG. 13 is a flow chart illustrating an exemplary methodology for facilitating multicarrier CQI feedback from a base station in accordance with an aspect of the subject specification.

FIG. 14 is an illustration of an exemplary communication system implemented in accordance with various aspects including multiple cells.

FIG. 15 is an illustration of an exemplary base station in accordance with various aspects described herein.

FIG. 16 is an illustration of an exemplary wireless terminal implemented in accordance with various aspects described herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA), High Speed Packet Access (HSPA), and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

High speed packet access (HSPA) can include high speed downlink packet access (HSDPA) technology and high speed uplink packet access (HSUPA) or enhanced uplink (EUL) technology and can also include HSPA+ technology. HSDPA, HSUPA and HSPA+ are part of the Third Generation Partnership Project (3GPP) specifications Release 5, Release 6, and Release 7, respectively.

High speed downlink packet access (HSDPA) optimizes data transmission from the network to the user equipment (UE). As used herein, transmission from the network to the user equipment UE can be referred to as the “downlink” (DL). Transmission methods can allow data rates of several Mbits/s. High speed downlink packet access (HSDPA) can increase the capacity of mobile radio networks. High speed uplink packet access (HSUPA) can optimize data transmission from the terminal to the network. As used herein, transmissions from the terminal to the network can be referred to as the “uplink” (UL). Uplink data transmission methods can allow data rates of several Mbit/s. HSPA+ provides even further improvements both in the uplink and downlink as specified in Release 7 of the 3GPP specification. High speed packet access (HSPA) methods typically allow for faster interactions between the downlink and the uplink in data services transmitting large volumes of data, for instance Voice over IP (VoIP), videoconferencing and mobile office applications

Fast data transmission protocols such as hybrid automatic repeat request, (HARQ) can be used on the uplink and downlink. Such protocols, such as hybrid automatic repeat request (HARQ), allow a recipient to automatically request retransmission of a packet that might have been received in error.

Various embodiments are described herein in connection with an access terminal. An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with access terminal(s) and can also be referred to as an access point, Node B, Evolved Node B (eNodeB) or some other terminology.

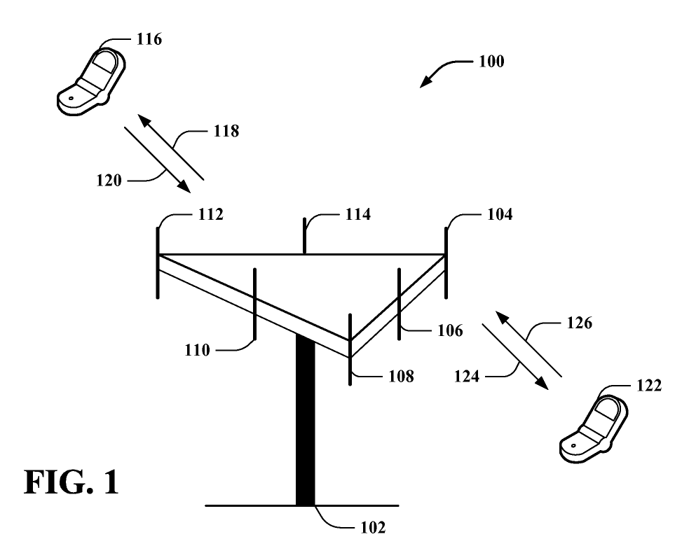

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more access terminals such as access terminal 116 and access terminal 122; however, it is to be appreciated that base station 102 can communicate with substantially any number of access terminals similar to access terminals 116 and 122. Access terminals 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, access terminal 116 is in communication with antennas 112 and 114, where antennas 112 and 114 transmit information to access terminal 116 over a forward link 118 and receive information from access terminal 116 over a reverse link 120. Moreover, access terminal 122 is in communication with antennas 104 and 106, where antennas 104 and 106 transmit information to access terminal 122 over a forward link 124 and receive information from access terminal 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to access terminals in a sector of the areas covered by base station 102. In communication over forward links 118 and 124, the transmitting antennas of base station 102 can utilize beamforming to improve signal-to-noise ratio of forward links 118 and 124 for access terminals 116 and 122. Also, while base station 102 utilizes beamforming to transmit to access terminals 116 and 122 scattered randomly through an associated coverage, access terminals in neighboring cells can be subject to less interference as compared to a base station transmitting through a single antenna to all its access terminals.

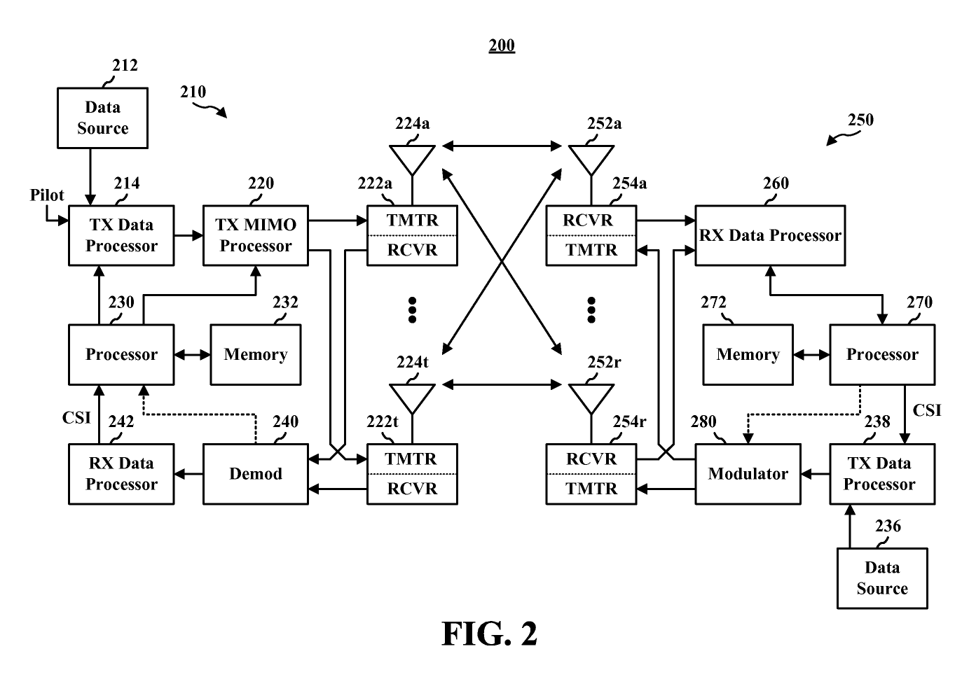

FIG. 2 shows an example wireless communication system 200. The wireless communication system 200 depicts one base station 210 and one access terminal 250 for sake of brevity. However, it is to be appreciated that system 200 can include more than one base station and/or more than one access terminal, wherein additional base stations and/or access terminals can be substantially similar or different from example base station 210 and access terminal 250 described below. In addition, it is to be appreciated that base station 210 and/or access terminal 250 can employ the systems and/or methods described herein to facilitate wireless communication there between.

At base station 210, traffic data for a number of data streams is provided from a data source 212 to a transmit (TX) data processor 214. According to an example, each data stream can be transmitted over a respective antenna. TX data processor 214 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at access terminal 250 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 230.

The modulation symbols for the data streams can be provided to a TX MIMO processor 220, which can further process the modulation symbols (e.g., for OFDM). TX MIMO processor 220 then provides N_{T} modulation symbol streams to N_{T} transmitters (TMTR) 222a through 222t. In various embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 222a through 222t are transmitted from N_{T} antennas 224a through 224t, respectively.

At access terminal 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective signal, digitizes the conditioned signal to provide samples, and further processes the samples to provide a corresponding “received” symbol stream.

An RX data processor 260 can receive and process the N_{R} received symbol streams from N_{R} receivers 254 based on a particular receiver processing technique to provide N_{T} “detected” symbol streams. RX data processor 260 can demodulate, deinterleave, and decode each detected symbol stream to recover the traffic data for the data stream. The processing by RX data processor 260 is complementary to that performed by TX MIMO processor 220 and TX data processor 214 at base station 210.

A processor 270 can periodically determine which available technology to utilize as discussed above. Further, processor 270 can formulate a reverse link message comprising a matrix index portion and a rank value portion.

The reverse link message can comprise various types of information regarding the communication link and/or the received data stream. The reverse link message can be processed by a TX data processor 238, which also receives traffic data for a number of data streams from a data source 236, modulated by a modulator 280, conditioned by transmitters 254a through 254r, and transmitted back to base station 210.

At base station 210, the modulated signals from access terminal 250 are received by antennas 224, conditioned by receivers 222, demodulated by a demodulator 240, and processed by a RX data processor 242 to extract the reverse link message transmitted by access terminal 250. Further, processor 230 can process the extracted message to determine which precoding matrix to use for determining the beamforming weights.

Processors 230 and 270 can direct (e.g., control, coordinate, manage, etc.) operation at base station 210 and access terminal 250, respectively. Respective processors 230 and 270 can be associated with memory 232 and 272 that store program codes and data. Processors 230 and 270 can also perform computations to derive frequency and impulse response estimates for the uplink and downlink, respectively.

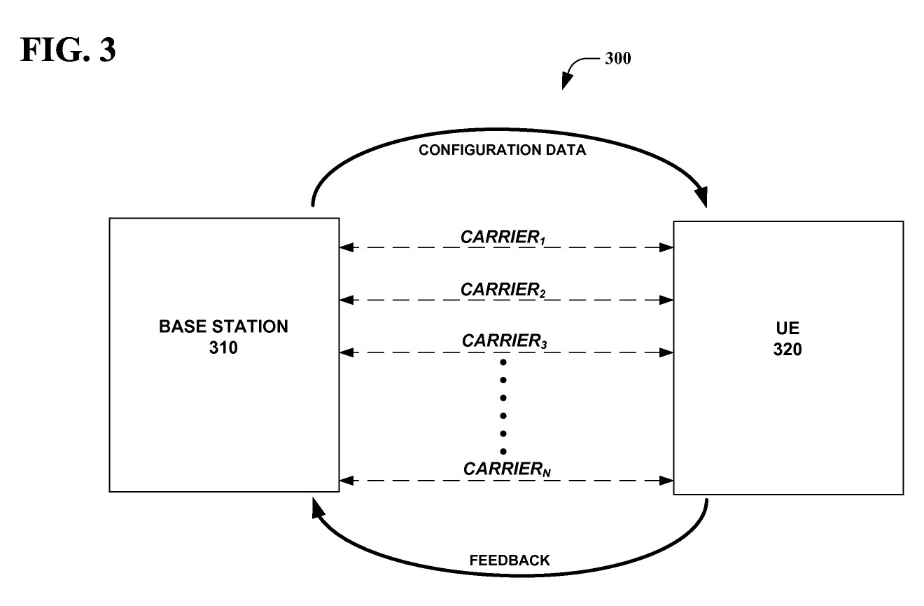

Referring next to FIG. 3, an exemplary system for facilitating multicarrier CQI feedback in accordance with some aspects is provided. As illustrated, system 300 includes a base station 310 engaged in a multicarrier communication of N carriers with a wireless terminal 320. In an aspect, wireless terminal 320 provides base station 310 with CQI feedback in the form of differential CQI values based on a common reference CQI value. Moreover, rather than sending actual CQI values for each of a subset of carriers, system 300 significantly conserves bandwidth by transmitting differential CQI values based on a single reference CQI value. By utilizing a differential CQI feedback scheme, CQI data for multiple downlink carriers may thus be provided to base station 310 in a single reporting instance. For instance, feedback may be reported over a plurality of reporting instances, wherein feedback information corresponding to at least two different carriers and/or at least two different sub-bands can be simultaneously reported in a single reporting instance. Furthermore, in addition to CQI data (actual or differential), it should be noted that feedback provided by wireless terminal 320 may also include a rank indicator (RI) and/or a pre-coding matrix indicator (PMI).

As illustrated in FIG. 3, base station 310 facilitates such differential CQI feedback by providing wireless terminal 320 with configuration data, which provides instructions for implementing a desired scheme for reporting CQI feedback to base station 310. For instance, the configuration data may include instructions directing the wireless terminal to monitor a particular subset of M carriers (wherein N≧M) and to identify a particular carrier as a reference carrier (e.g., the carrier with the highest CQI value).

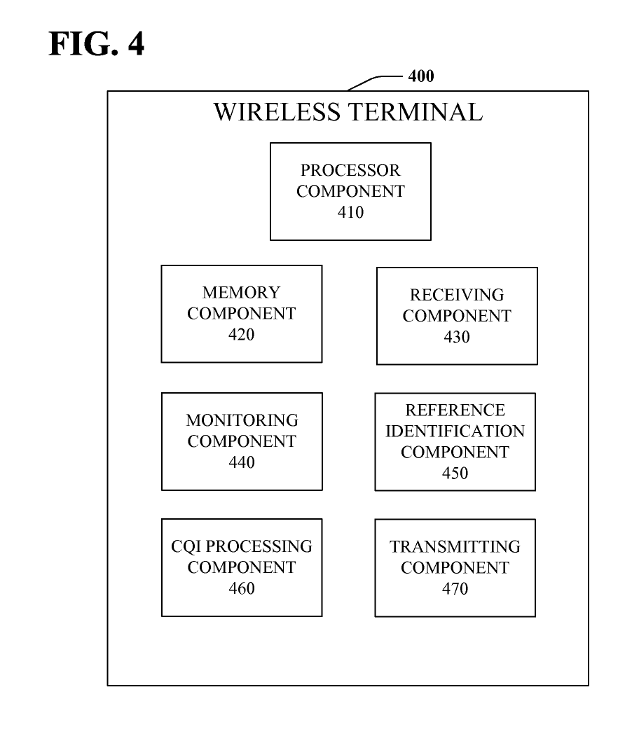

Referring next to FIG. 4, a block diagram of an exemplary wireless terminal that facilitates multicarrier CQI feedback in a wireless communication environment is provided. As shown, wireless terminal 400 may include processor component 410, memory component 420, receiving component 430, monitoring component 440, reference identification component 450, CQI processing component 460, and transmitting component 470.

In one aspect, processor component 410 is configured to execute computer-readable instructions related to performing any of a plurality of functions. Processor component 410 can be a single processor or a plurality of processors dedicated to analyzing information to be communicated from wireless terminal 400 and/or generating information that can be utilized by memory component 420, receiving component 430, monitoring component 440, reference identification component 450, CQI processing component 460, and/or transmitting component 470. Additionally or alternatively, processor component 410 may be configured to control one or more components of wireless terminal 400.

In another aspect, memory component 420 is coupled to processor component 410 and configured to store computer-readable instructions executed by processor component 410. Memory component 420 may also be configured to store any of a plurality of other types of data including configuration data received via receiving component 430, as well as data generated by any of receiving component 430, monitoring component 440, reference identification component 450, CQI processing component 460, and/or transmitting component 470. Memory component 420 can be configured in a number of different configurations, including as random access memory, battery-backed memory, hard disk, magnetic tape, etc. Various features can also be implemented upon memory component 420, such as compression and automatic back up (e.g., use of a Redundant Array of Independent Drives configuration).

In yet another aspect, receiving component 430 and transmitting component 470 are also coupled to processor component 410 and configured to interface wireless terminal 400 with external entities. For instance, receiving component 430 may be configured to receive a signal from a base station via any of a plurality of carriers (e.g., signal may include configuration data received from a base station), whereas transmitting component 470 may be configured to report each of a reference CQI value and a differential CQI value to a base station (e.g., the transmitting component may facilitate transmitting the reference CQI value and cycling through the differential CQI values as a function of a desired reporting sequence included in the configuration data).

In some aspects, wireless terminal 400 may also include monitoring component 440, which may be configured to monitor a signal received from a base station. In an embodiment, monitoring component 440 is configured to monitor a particular subset of carriers utilized by the signal, wherein the subset of carriers are identified as a function of configuration data received from a base station. Within such embodiment, it should be appreciated that the subset of carriers may include a reference carrier and at least one non-reference carrier.

As illustrated, wireless terminal 400 may further include reference identification component 450, which may be configured to identify a reference carrier within the aforementioned subset of carriers. Here, it should be appreciated that such reference carrier may be identified according to any of a plurality of methods including algorithms pre-programmed into wireless terminal 400 and/or included in configuration data received from a base station. For instance, reference identification component 450 may be configured to ascertain a CQI value for each of the subset of carriers, wherein the reference carrier is identified as a function of comparing the CQI values for each of the subset of carriers (e.g., by identifying the reference carrier as the carrier with the highest CQI value amongst the subset of carriers). In other aspects, reference identification component 450 may be configured to identify the reference carrier according to a particular carrier and/or rotation of carriers identified by the configuration data.

In another aspect, wireless terminal 400 may further include CQI processing component 460, which may be configured to ascertain a reference CQI value and at least one differential CQI value. Within such embodiment, the reference CQI value corresponds to a reference carrier, whereas each of the differential CQI values derived from the reference CQI value. CQI processing component 460 may also be configured to perform any of a plurality of functions for ascertaining wideband/sub-band CQI values. For instance, CQI processing component 460 may be configured to ascertain sub-band CQI values by defining bandwidth parts for each configured carrier.

It should be further noted that, for some embodiments, the configuration data includes data identifying a desired CQI granularity, wherein CQI processing component 460 is configured to ascertain the reference CQI value and the differential CQI values as a function of the desired CQI granularity. The configuration data may also include data identifying a desired bit length for the reference CQI value and/or the differential CQI values, wherein CQI processing component 460 is configured to ascertain the reference CQI value and/or the differential CQI values as a function of the desired bit length.

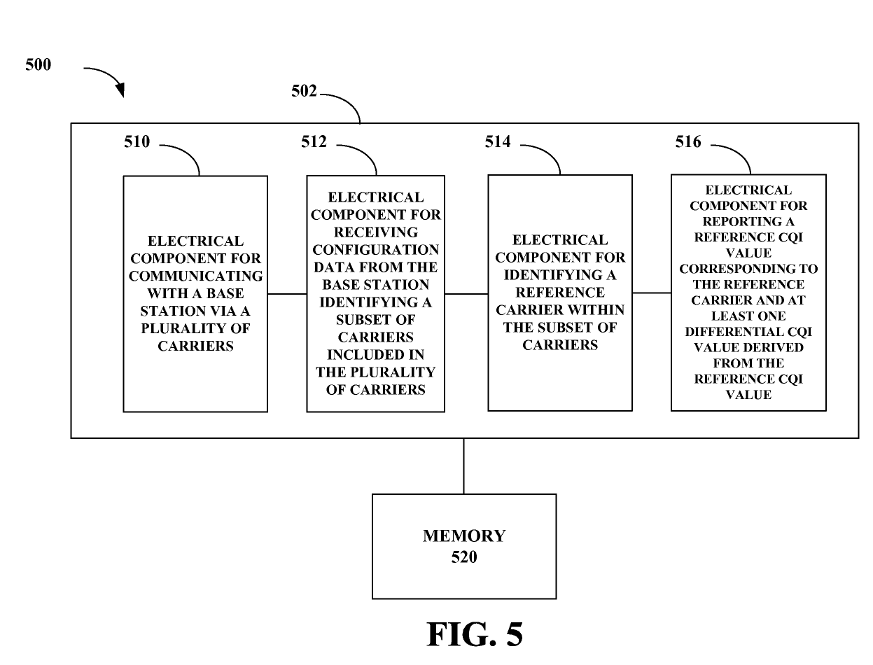

Turning to FIG. 5, illustrated is a system 500 that facilitates multicarrier CQI feedback in a wireless communication environment. System 500 can reside within a wireless terminal, for instance. As depicted, system 500 includes functional blocks that can represent functions implemented by a processor, software, or combination thereof (e.g., firmware). System 500 includes a logical grouping 502 of electrical components that can act in conjunction. As illustrated, logical grouping 502 can include an electrical component for communicating with a base station via a plurality of carriers 510. Logical grouping 502 can also include an electrical component for receiving configuration data from the base station identifying a subset of carriers included in the plurality of carriers 512, as well as an electrical component for identifying a reference carrier within the subset of carriers 514. Furthermore, logical grouping 502 can include an electrical component for reporting a reference CQI value corresponding to the reference carrier and at least one differential CQI value derived from the reference CQI value 516. Additionally, system 500 can include a memory 520 that retains instructions for executing functions associated with electrical components 510, 512, 514, 516, and 518. While shown as being external to memory 520, it is to be understood that electrical components 510, 512, 514, 516, and 518 can exist within memory 520.

In a particular embodiment, a wireless terminal provides CQI differential feedback relative to a reference carrier having the highest CQI value, which provides the best accuracy for the highest spectral efficiency. Within such embodiment, the wireless terminal reports the CQI value of the “best” carrier and the index of the best carrier. In an aspect, the CQI values for the non-reference carriers are reported in a predetermined “wrap-around” order following the best carrier index, wherein such wrap-around order may have been included in configuration data provided to the wireless terminal. For example, if the best carrier index is three, and there are five configured carriers, the reporting order is Carrier₃, Carrier₄, Carrier₅, Carrier₁, and Carrier₂.

Depending on the mode, it should be noted that a best carrier report could be provided via spatial multiplexing per code word. For instance, the first code word may be four bits and correspond to the actual CQI value of the best carrier, whereas each subsequent code word may be three bits and correspond to a differential CQI value relative to the CQI value of the best carrier. Here, if a wireless terminal indeed reports CQI values per code word, it should be further noted that a scheme having a single pre-coding matrix over all carriers would require a single pre-coding matrix indicator to be reported, whereas a scheme having a single pre-coding matrix for each carrier would require a pre-coding matrix indicator per carrier to be reported.

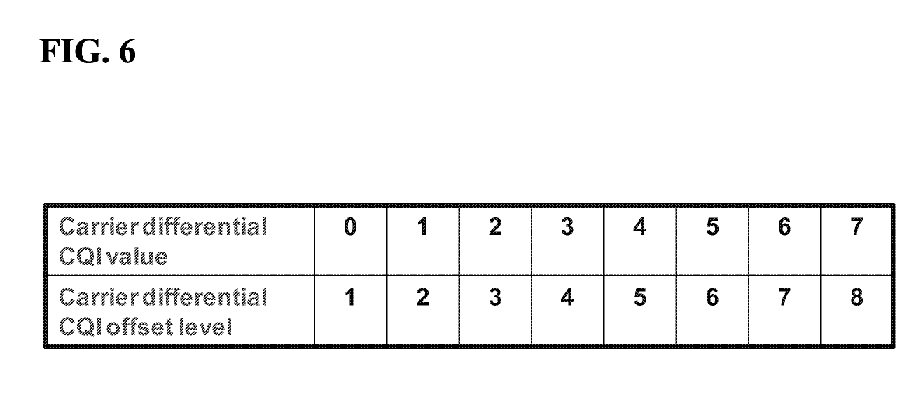

For some embodiments, multicarrier feedback is facilitated by mapping carrier differential CQI offset levels to carrier differential CQI values. For instance, such offset levels may correspond to a difference between the index of the best carrier and the respective indices of the remaining carriers. In FIG. 6, an exemplary mapping of carrier differential CQI offset levels to carrier differential CQI values is provided. For this particular embodiment, it should be appreciated that carrier differential CQI values may be reported either via two or three bits depending on the desired granularity.

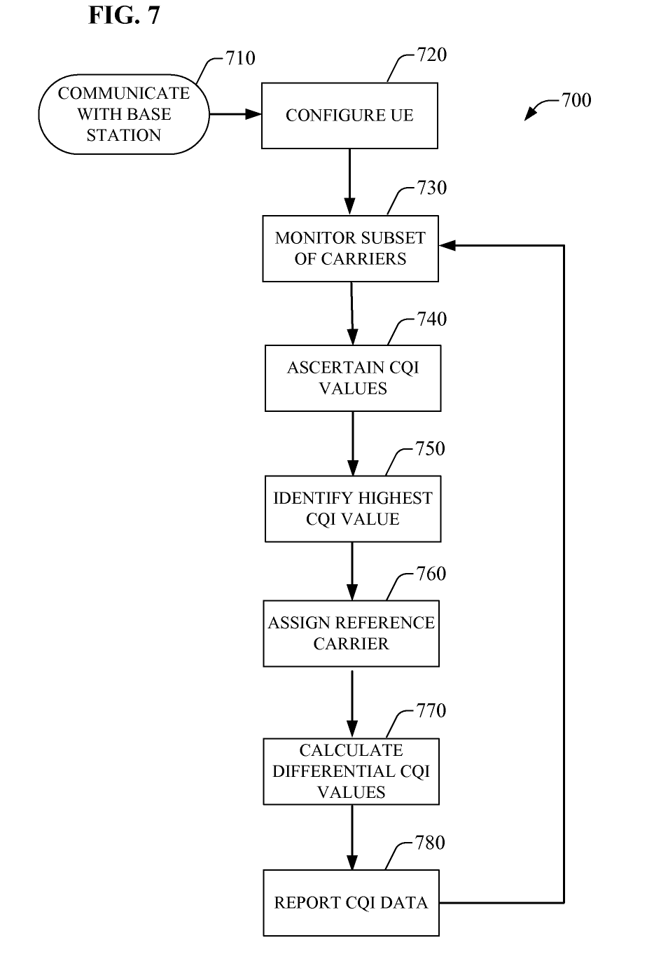

Referring next to FIG. 7, a flow chart illustrating an exemplary methodology for facilitating multicarrier CQI feedback via reference carriers selected as a function of CQI value is provided. As illustrated, process 700 includes a series of steps that may be performed by a wireless terminal. For instance, process 700 may be implemented by employing a processor to execute computer executable instructions stored on a computer readable storage medium to implement the series of steps. In another embodiment, a computer-readable storage medium comprising code for implementing the steps of process 700 are contemplated.

In an aspect, process 700 begins by establishing a multicarrier communication with a base station at step 710. Next, at step 720, the wireless terminal is configured with configuration data received from the base station. Here, it should be appreciated that such configuration data may include instructions directing the wireless terminal to facilitate multicarrier CQI feedback in any of a plurality of ways. For instance, at step 730, process 700 may proceed with the wireless terminal monitoring a particular subset of carriers specified by the received configuration data. At step 740, the wireless terminal may then ascertain a CQI value for each of the subset of carriers monitored at step 730.

Upon ascertaining a CQI value for each of the subset of carriers, it should be appreciated that any of a plurality of methods may be used to select an appropriate reference carrier based on the ascertained CQI values. For this particular embodiment, process 700 proceeds with an identification of the carrier with the highest CQI value at step 750. Next, at step 760, the reference carrier is assigned to be the carrier identified as having the highest CQI value. Differential CQI values are then calculated relative to the reference carrier at step 770 for each of the remaining carriers in the subset of monitored carriers.

Once the differential CQI values have been calculated, the CQI data is then reported to the base station at step 780 followed by process 700 looping back to step 730 where the subset of carriers identified in the configuration data continue to be monitored. For some embodiments, it should be noted that CQI data is reported according to instructions provided by the configuration data. For instance, the configuration data may include data identifying a desired reporting sequence, wherein the wireless terminal reports the reference CQI value and the differential CQI values as a function of the desired reporting sequence. In another embodiment, the configuration data includes data identifying a desired CQI granularity (e.g., data identifying a desired bit length for the reference CQI value and/or a differential CQI value), wherein the wireless terminal reports the reference CQI value and the differential CQI values as a function of the desired CQI granularity.

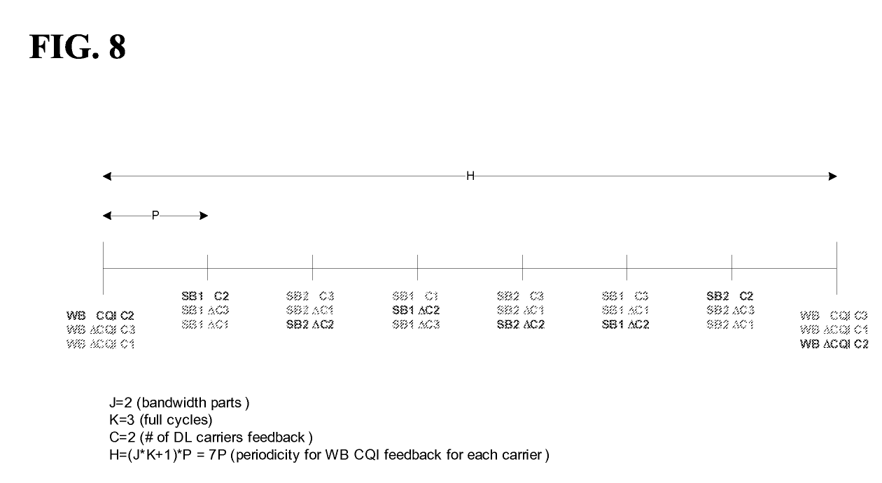

In an aspect, the CQI value of the best carrier and the differential CQI values of the remaining configured carriers either correspond to a particular wideband CQI per carrier or a sub-band CQI per carrier. For sub-band CQI values, a plurality of bandwidth parts are defined for each carrier, depending on the carrier bandwidth, which respectively correspond to a plurality of sub-band CQI values. For instance, in an aspect, each of a plurality of non-reference carriers has a corresponding differential CQI value relative to a reference CQI value (e.g., a highest wideband CQI value amongst a subset of carriers), wherein the maximum among the number of bandwidth parts for each downlink carrier is adoptable as a configuration parameter. Within such embodiment, a wireless terminal cycles through each bandwidth part in different reporting instances, wherein one bandwidth part for each configured carrier is reported per reporting instance. In FIG. 8, a diagram illustrating an exemplary scheme for reporting each sub-band CQI value is provided.

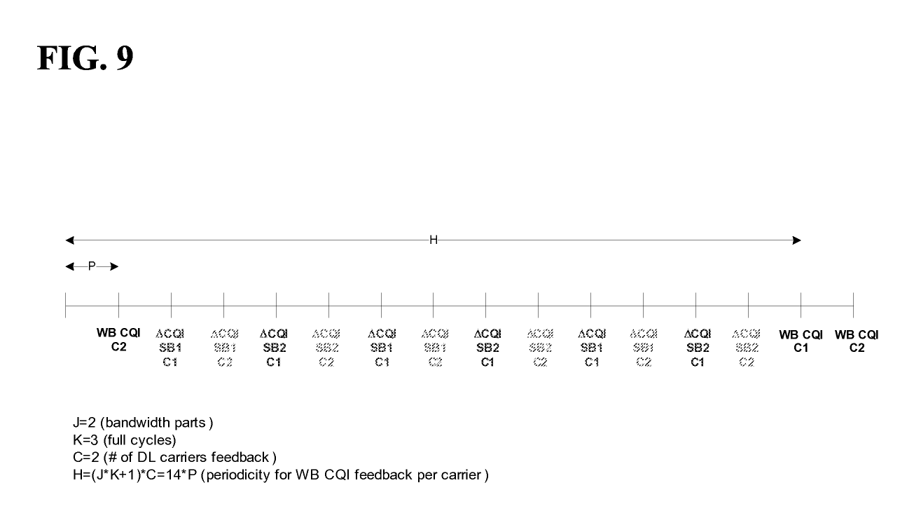

For some embodiments, rather than reporting differential CQI values with respect to the best carrier CQI value, differential CQI values are reported with respect to a wideband CQI value. Here, it should be noted that wideband CQI values across all configured carriers are redundant if MCS selection is performed per carrier rather than jointly across carriers. The wideband CQI report can also be defined per carrier, and differential CQI reports could be provided with respect to the corresponding carrier wideband CQI report. When reporting differential values with respect to a wideband CQI value, one differential CQI value corresponding to a particular carrier is reported in each reporting interval. Within such embodiment, full CQI reports are sent periodically, while in between them, the differential CQI values per carrier (wideband or sub-band) are reported. For instance, a first wideband CQI value corresponding to a first reference carrier may be reported in a first reporting instance followed by the reporting of a second wideband CQI value corresponding to a second reference carrier in a second reporting instance, wherein a series of differential CQI values may be reported in between. In FIG. 9, a diagram illustrating an exemplary scheme for reporting differential values with respect to a wideband CQI value is provided.

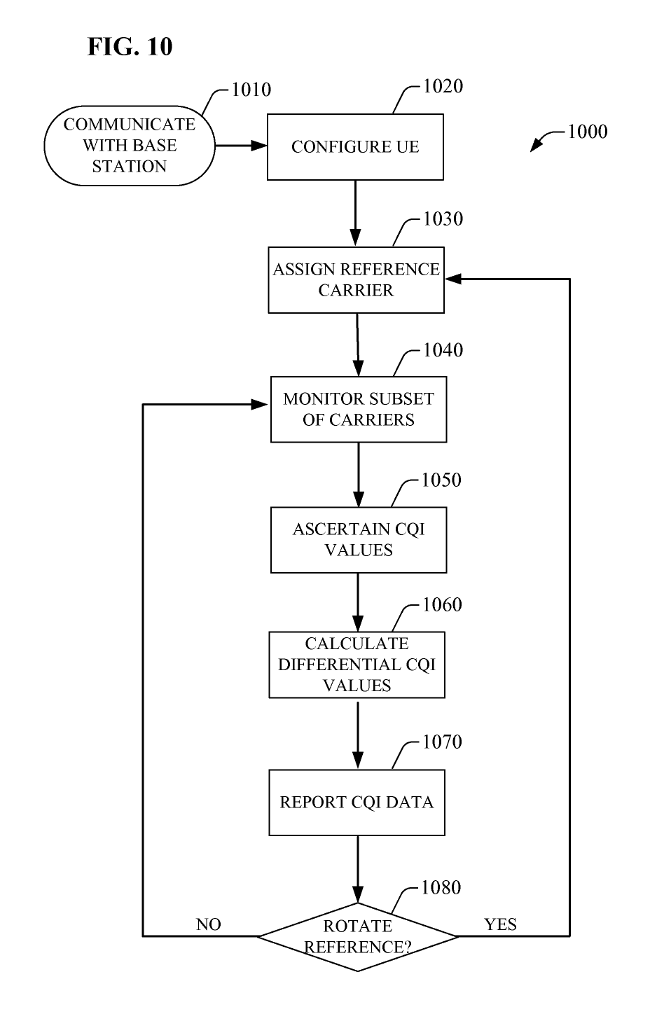

Referring next to FIG. 10, a flow chart illustrating an exemplary methodology for facilitating multicarrier CQI feedback via predetermined reference carriers is provided. As illustrated, process 1000 includes a series of steps that may be performed by a wireless terminal. For instance, process 1000 may be implemented by employing a processor to execute computer executable instructions stored on a computer readable storage medium to implement the series of steps. In another embodiment, a computer-readable storage medium comprising code for implementing the steps of process 1000 are contemplated.

In an aspect, process 1000 begins by establishing a multicarrier communication with a base station at step 1010. Next, at step 1020, the wireless terminal is configured with configuration data received from the base station. For this particular embodiment, the configuration data includes instructions for selecting predetermined reference carriers at step 1030. For instance, the configuration data may instruct the wireless terminal to calculate differential CQI values relative to a particular reference carrier, wherein the same reference carrier is used for each reporting interval. In another embodiment, the configuration data identifies a rotation of reference carriers, wherein the reference carrier for each reporting interval varies according to the rotation. The reference carrier can also be identified as the carrier with the highest CQI value, wherein an identification of the reference carrier is reported to the base station each reporting interval.

At step 1040, process 1000 proceeds with the wireless terminal monitoring a particular subset of carriers specified by the received configuration data. At step 1050, the wireless terminal may then ascertain a CQI value for each of the subset of carriers monitored at step 1040. Differential CQI values are then calculated relative to the reference carrier at step 1060 for each of the non-reference carriers in the subset of monitored carriers.

Once the differential CQI values have been calculated, the CQI feedback may then be provided to the base station at step 1070. As stated previously with respect to process 700, CQI data may be reported according to instructions provided by the configuration data. For instance, the configuration data may include data identifying a desired reporting sequence, wherein the wireless terminal reports the reference CQI value and the differential CQI values as a function of the desired reporting sequence. In another embodiment, the configuration data includes data identifying a desired CQI granularity (e.g., data identifying a desired bit length for the reference CQI value and/or a differential CQI value), wherein the wireless terminal reports the reference CQI value and the differential CQI values as a function of the desired CQI granularity. In yet another embodiment, the configuration data includes instructions for rotating reference carriers, wherein the wireless terminal may be initially instructed to ascertain a first reference CQI value for reporting a first set of reporting instances.

After each reporting interval, process 1000 continues to step 1080 where a determination of whether to rotate reference carriers is made. If a determination is made to rotate reference carriers, process 1000 loops back to step 1030 where a new reference carrier is assigned. Otherwise, if no rotation is desired, the current reference carrier is retained and process 1000 loops back to monitoring carriers at step 1040. Depending on the particular configuration data received from the base station, it should be noted that the determination performed at step 1080 may vary. For instance, a rotation may not occur if the wireless terminal is configured to utilize the same reference carrier for each reporting interval. In other embodiments, even if a rotation scheme is implemented, the non-occurrence of a particular trigger may preclude a rotation (e.g., where the scheme dictates that such rotation occur after a finite number of reporting intervals and/or that such rotation be partly based on the ascertained CQI values).

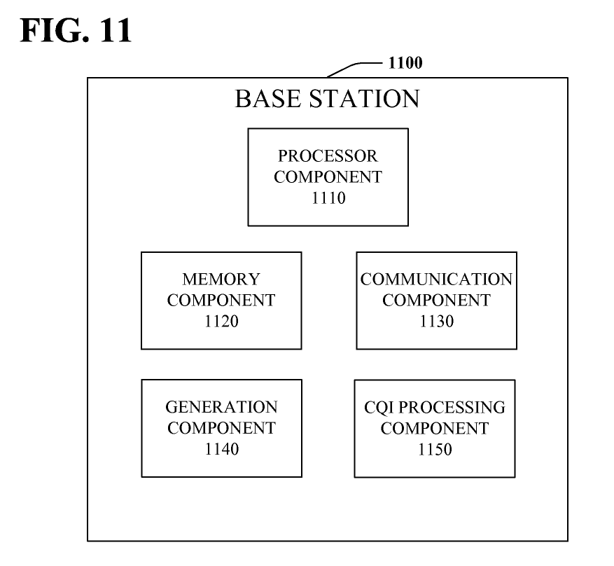

Referring next to FIG. 11, a block diagram of an exemplary base station that facilitates multicarrier CQI feedback in a wireless communication environment is provided. As shown, base station 1100 may include processor component 1110, memory component 1120, communication component 1130, generation component 1140, and CQI processing component 1150.

In one aspect, processor component 1110 is configured to execute computer-readable instructions related to performing any of a plurality of functions. Processor component 1110 can be a single processor or a plurality of processors dedicated to analyzing information to be communicated from base station 1100 and/or generating information that can be utilized by memory component 1120, communication component 1130, generation component 1140, and/or CQI processing component 1150. Additionally or alternatively, processor component 1110 may be configured to control one or more components of base station 1100.

In another aspect, memory component 1120 is coupled to processor component 1110 and configured to store computer-readable instructions executed by processor component 1110. Memory component 1120 may also be configured to store any of a plurality of other types of data including data generated by any of communication component 1130, generation component 1140, and/or CQI processing component 1150. Memory component 1120 can be configured in a number of different configurations, including as random access memory, battery-backed memory, hard disk, magnetic tape, etc. Various features can also be implemented upon memory component 1120, such as compression and automatic back up (e.g., use of a Redundant Array of Independent Drives configuration).

In yet another aspect, communication component 1130 is also coupled to processor component 1110 and configured to interface base station 1100 with external entities. For instance, communication component 1130 may be configured to facilitate a communication with a wireless terminal via a plurality of carriers. In an embodiment, the communication includes transmitting configuration data to the wireless terminal, and receiving CQI data from the wireless terminal.

As illustrated, base station 1100 may further include generation component 1140, which may be configured to generate the configuration data. Here, it should be appreciated that generation component 1140 may generate the configuration data to include any of a plurality of instructions for a wireless terminal. For instance, instructions may be provided for identifying a subset of carriers for the wireless terminal to monitor, as well as instructions for identifying a reference carrier amongst the subset of carriers. In one aspect, the configuration data includes instructions for directing the wireless terminal to ascertain a CQI value for each of the subset of carriers and to identify the reference carrier as a function of comparing the CQI values for each of the subset of carriers (e.g., directing the wireless terminal to identify the carrier with the highest CQI value as the reference carrier). In other aspects, however, the configuration data may simply direct the wireless terminal to identify a particular carrier as the reference carrier and/or to identify reference carriers according to a rotation of reference carriers identified by the configuration data.

For some embodiments, generation component 1140 may also embed the configuration data with instructions for reporting CQI data from a wireless terminal. For instance, configuration data may be embedded with instructions directing the wireless terminal to report CQI values (e.g., a reference CQI value and a differential CQI value) as a function of a desired reporting sequence identified by the configuration data. In other embodiments, the configuration data is generated to include instructions directing the wireless terminal to report CQI values (e.g., a reference CQI value and a differential CQI value) as a function of a desired CQI granularity identified by the configuration data. To facilitate such a desired CQI granularity, configuration data may be generated to include instructions directing the wireless terminal to report CQI values (e.g., a reference CQI value and/or a differential CQI value) as a function of a desired bit length identified by the configuration data (e.g., a desired bit length for the reference CQI value and/or any of the differential CQI values).

In another aspect, base station 1100 may further include CQI processing component 1150. Here, it should be appreciated that CQI processing component 1150 may be configured to process CQI data received from a wireless terminal in any of a plurality of ways. For instance, since base station 1100 may receive CQI data from any of several wireless terminals, CQI processing component 1150 may be configured to process CQI data according to an identification scheme that distinguishes between the various wireless terminals. Indeed, since base station 1100 may configure various wireless terminals differently (e.g., by providing configuration data instructing the wireless terminals to monitor different sets of sub-carriers), CQI processing component 1150 may be configured to process CQI data received from a particular wireless terminal according to the unique configuration data corresponding to that wireless terminal.

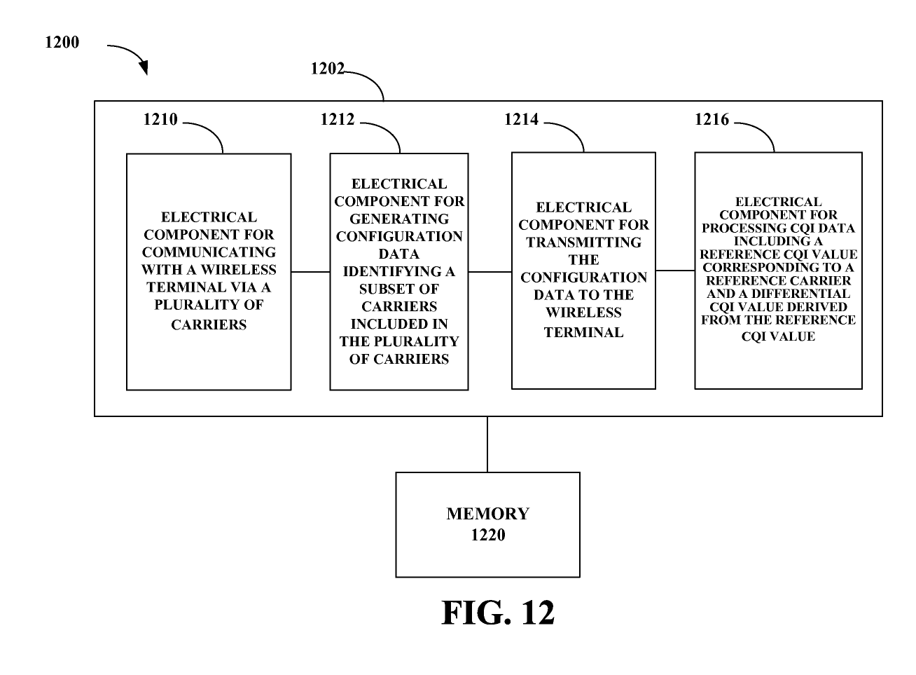

Referring next to FIG. 12, illustrated is a system 1200 that facilitates multicarrier CQI feedback in a wireless communication environment. System 1200 can reside within a base station, for instance, wherein system 1200 includes functional blocks that can represent functions implemented by a processor, software, or combination thereof (e.g., firmware). Moreover, system 1200 includes a logical grouping 1202 of electrical components that can act in conjunction similar to logical grouping 502 in system 500. As illustrated, logical grouping 1202 can include an electrical component for communicating with a wireless terminal via a plurality of carriers 1210. Logical grouping 1202 can also include an electrical component for generating configuration data identifying a subset of carriers included in the plurality of carriers 1212, as well as an electrical component for transmitting the configuration data to the wireless terminal 1214. Furthermore, logical grouping 1202 can include an electrical component for processing CQI data received from a wireless terminal including a reference CQI value corresponding to a reference carrier and a differential CQI value derived from the reference CQI value 1216. Additionally, system 1200 can include a memory 1220 that retains instructions for executing functions associated with electrical components 1210, 1212, 1214, and 1216. While shown as being external to memory 1220, it is to be understood that electrical components 1210, 1212, 1214, and 1216 can exist within memory 1220.

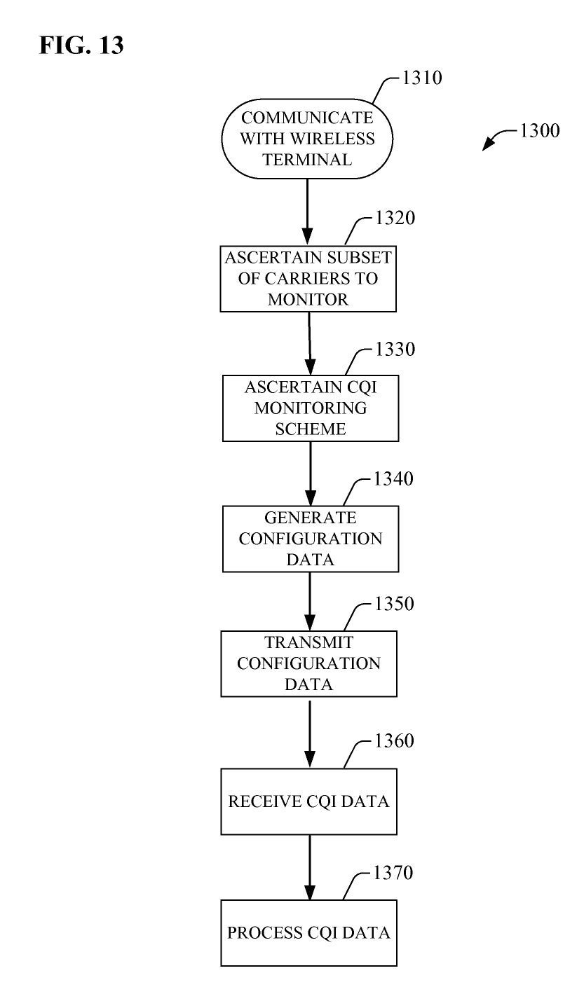

Referring next to FIG. 13, a flow chart illustrating an exemplary methodology for facilitating multicarrier CQI feedback from a base station is provided. As illustrated, process 1300 includes a series of steps that may be performed by a base station. For instance, process 1300 may be implemented by employing a processor to execute computer executable instructions stored on a computer readable storage medium to implement the series of steps. In another embodiment, a computer-readable storage medium comprising code for implementing the steps of process 1300 are contemplated.

In an aspect, process 1300 begins by establishing a multicarrier communication with a wireless terminal at step 1310. Next, at step 1320, the base station ascertains a particular subset of carriers for which to direct the wireless terminal to monitor. Process 1300 then continues to step 1330 where the base station ascertains a desired scheme for monitoring the subset of carriers. The base station then generates configuration data at step 1340, which encodes the desired monitoring scheme and identifies the subset of carriers. Once generated, the configuration data is subsequently transmitted to the wireless terminal at step 1350.

In various embodiments, the configuration data generated at step 1340 may include instructions for monitoring the identified subset of carriers in any of a plurality of ways. For instance, the configuration data may include instructions for selecting a reference carrier as a function of each carriers CQI value (e.g., by comparing particular CQI values, identifying the carrier with the highest CQI value, etc.) and/or selecting predetermined reference carriers (e.g., using the same reference carrier for each reporting interval, rotating reference carriers as a function of the reporting cycle, etc.). The configuration data may also include instructions for reporting CQI values according to a desired reporting sequence (e.g., reporting the reference CQI value and the differential CQI values as a function of the desired reporting sequence) and/or a desired CQI granularity (e.g., reporting CQI values according to a desired bit length for the reference CQI value and/or a differential CQI value).

After transmitting configuration data at step 1350, process 1300 continues with the base station receiving CQI data from the wireless terminal at step 1360 and subsequently processing the CQI data at step 1370. Here, because the base station may configure wireless terminals differently, it should be appreciated that the processing of CQI data at step 1370 may further require identifying the particular configuration of the wireless terminal providing the CQI feedback.

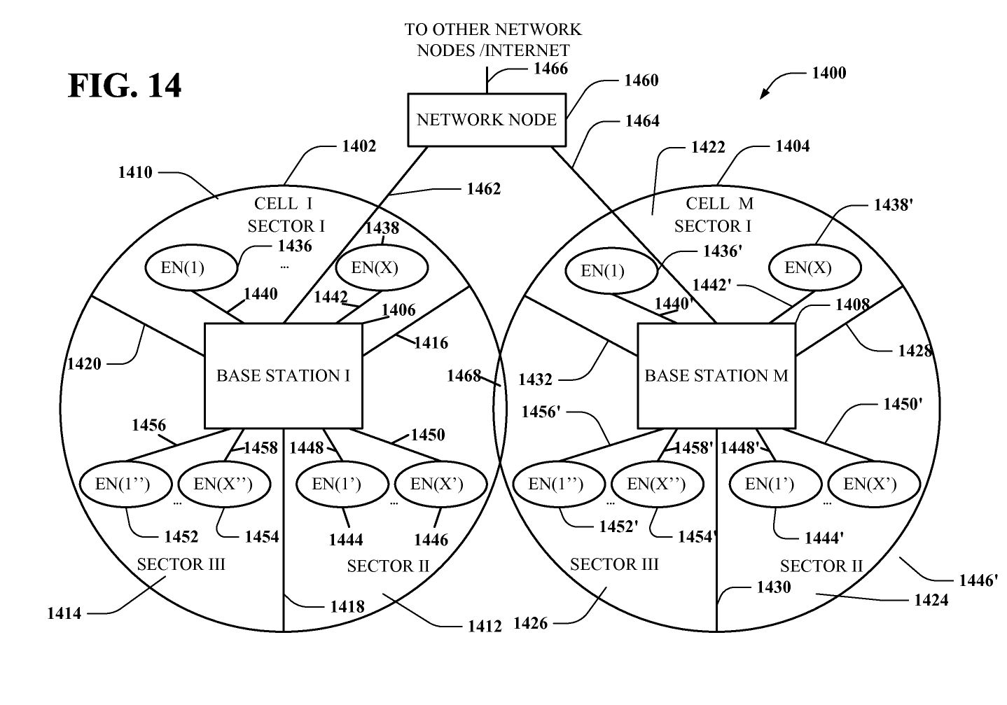

Referring next to FIG. 14, an exemplary communication system 1400 implemented in accordance with various aspects is provided including multiple cells: cell 11402, cell M 1404. Here, it should be noted that neighboring cells 1402, 1404 overlap slightly, as indicated by cell boundary region 1468, thereby creating potential for signal interference between signals transmitted by base stations in neighboring cells. Each cell 1402, 1404 of system 1400 includes three sectors. Cells which have not been subdivided into multiple sectors (N=1), cells with two sectors (N=2) and cells with more than 3 sectors (N>3) are also possible in accordance with various aspects. Cell 1402 includes a first sector, sector 11410, a second sector, sector II 1412, and a third sector, sector III 1414. Each sector 1410, 1412, 1414 has two sector boundary regions; each boundary region is shared between two adjacent sectors.

Sector boundary regions provide potential for signal interference between signals transmitted by base stations in neighboring sectors. Line 1416 represents a sector boundary region between sector 11410 and sector II 1412; line 1418 represents a sector boundary region between sector II 1412 and sector III 1414; line 1420 represents a sector boundary region between sector III 1414 and sector 1 1410. Similarly, cell M 1404 includes a first sector, sector 11422, a second sector, sector II 1424, and a third sector, sector III 1426. Line 1428 represents a sector boundary region between sector 11422 and sector II 1424; line 1430 represents a sector boundary region between sector II 1424 and sector III 1426; line 1432 represents a boundary region between sector III 1426 and sector 11422. Cell 11402 includes a base station (BS), base station 11406, and a plurality of end nodes (ENs) in each sector 1410, 1412, 1414. Sector 11410 includes EN(1) 1436 and EN(X) 1438 coupled to BS 1406 via wireless links 1440, 1442, respectively; sector II 1412 includes EN(1′) 1444 and EN(X′) 1446 coupled to BS 1406 via wireless links 1448, 1450, respectively; sector III 1414 includes EN(1″) 1452 and EN(X″) 1454 coupled to BS 1406 via wireless links 1456, 1458, respectively. Similarly, cell M 1404 includes base station M 1408, and a plurality of end nodes (ENs) in each sector 1422, 1424, 1426. Sector 11422 includes EN(1) 1436′ and EN(X) 1438′ coupled to BS M 1408 via wireless links 1440′, 1442′, respectively; sector II 1424 includes EN(1′) 1444′ and EN(X′) 1446′ coupled to BS M 1408 via wireless links 1448′, 1450′, respectively; sector 3 1426 includes EN(1″) 1452′ and EN(X″) 1454′ coupled to BS 1408 via wireless links 1456′, 1458′, respectively.

System 1400 also includes a network node 1460 which is coupled to BS I 1406 and BS M 1408 via network links 1462, 1464, respectively. Network node 1460 is also coupled to other network nodes, e.g., other base stations, AAA server nodes, intermediate nodes, routers, etc. and the Internet via network link 1466. Network links 1462, 1464, 1466 may be, e.g., fiber optic cables. Each end node, e.g. EN 1 1436 may be a wireless terminal including a transmitter as well as a receiver. The wireless terminals, e.g., EN(1) 1436 may move through system 1400 and may communicate via wireless links with the base station in the cell in which the EN is currently located. The wireless terminals, (WTs), e.g. EN(1) 1436, may communicate with peer nodes, e.g., other WTs in system 1400 or outside system 1400 via a base station, e.g. BS 1406, and/or network node 1460. WTs, e.g., EN(1) 1436 may be mobile communications devices such as cell phones, personal data assistants with wireless modems, etc. Respective base stations perform tone subset allocation using a different method for the strip-symbol periods, from the method employed for allocating tones and determining tone hopping in the rest symbol periods, e.g., non strip-symbol periods. The wireless terminals use the tone subset allocation method along with information received from the base station, e.g., base station slope ID, sector ID information, to determine tones that they can employ to receive data and information at specific strip-symbol periods. The tone subset allocation sequence is constructed, in accordance with various aspects to spread inter-sector and inter-cell interference across respective tones. Although the subject system was described primarily within the context of cellular mode, it is to be appreciated that a plurality of modes may be available and employable in accordance with aspects described herein.

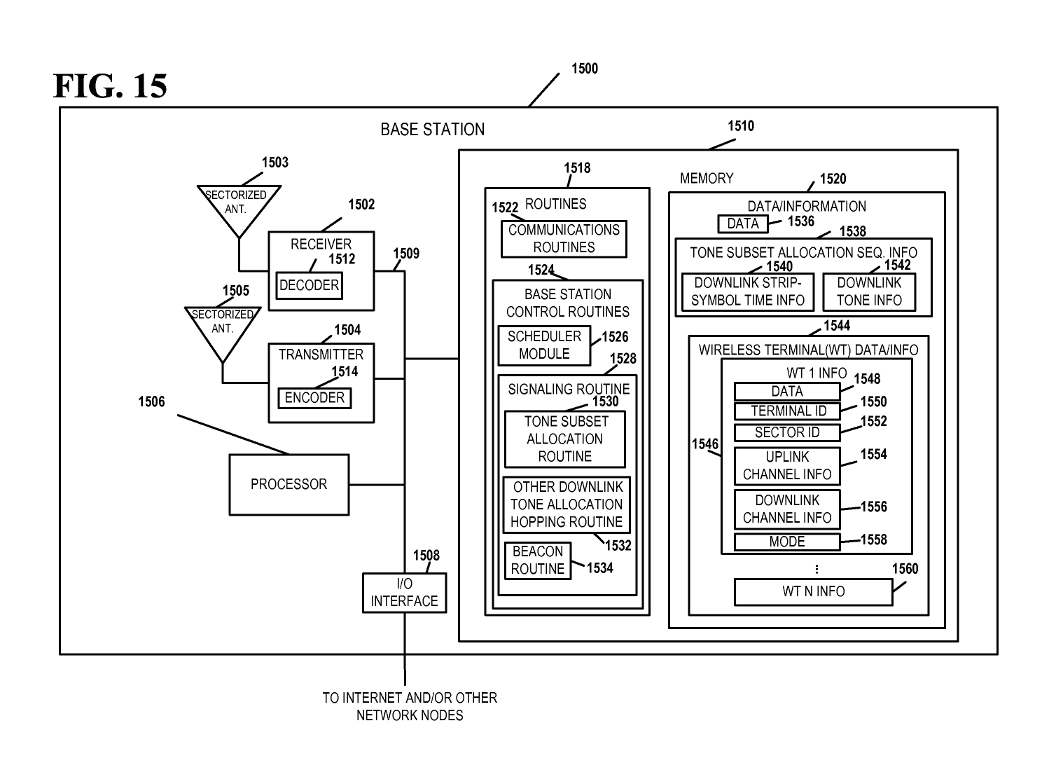

FIG. 15 illustrates an example base station 1500 in accordance with various aspects. Base station 1500 implements tone subset allocation sequences, with different tone subset allocation sequences generated for respective different sector types of the cell. Base station 1500 may be used as any one of base stations 1406, 1408 of the system 1400 of FIG. 14. The base station 1500 includes a receiver 1502, a transmitter 1504, a processor 1506, e.g., CPU, an input/output interface 1508 and memory 1510 coupled together by a bus 1509 over which various elements 1502, 1504, 1506, 1508, and 1510 may interchange data and information.

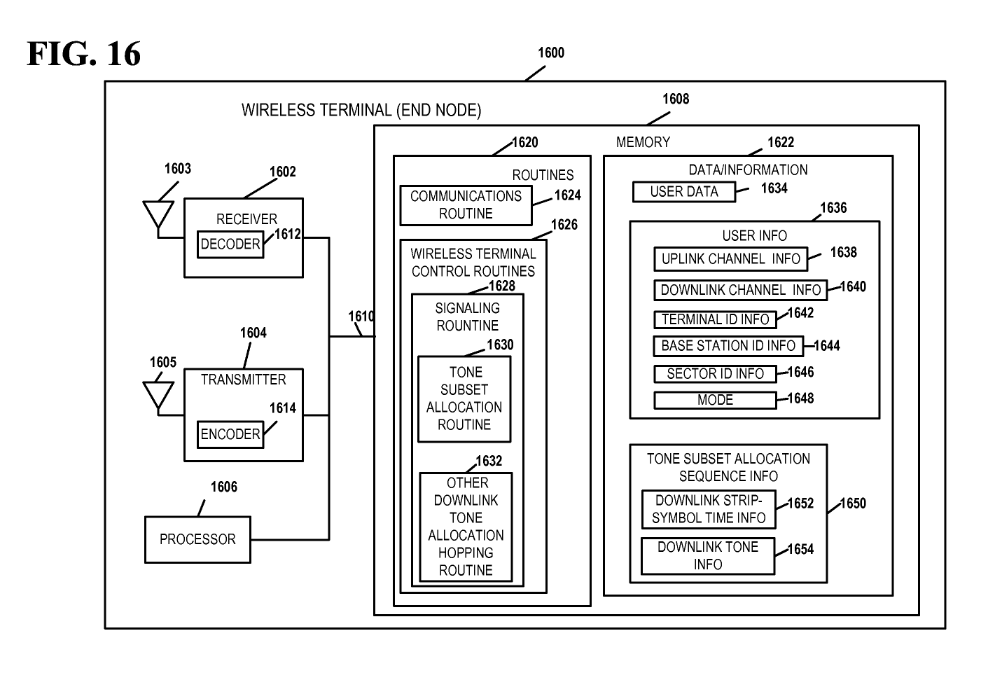

Sectorized antenna 1503 coupled to receiver 1502 is used for receiving data and other signals, e.g., channel reports, from wireless terminals transmissions from each sector within the base station's cell. Sectorized antenna 1505 coupled to transmitter 1504 is used for transmitting data and other signals, e.g., control signals, pilot signal, beacon signals, etc. to wireless terminals 1600 (see FIG. 16) within each sector of the base station's cell. In various aspects, base station 1500 may employ multiple receivers 1502 and multiple transmitters 1504, e.g., an individual receivers 1502 for each sector and an individual transmitter 1504 for each sector. Processor 1506, may be, e.g., a general purpose central processing unit (CPU). Processor 1506 controls operation of base station 1500 under direction of one or more routines 1518 stored in memory 1510 and implements the methods. I/O interface 1508 provides a connection to other network nodes, coupling the BS 1500 to other base stations, access routers, AAA server nodes, etc., other networks, and the Internet. Memory 1510 includes routines 1518 and data/information 1520.

Data/information 1520 includes data 1536, tone subset allocation sequence information 1538 including downlink strip-symbol time information 1540 and downlink tone information 1542, and wireless terminal (WT) data/info 1544 including a plurality of sets of WT information: WT 1 info 1546 and WT N info 1560. Each set of WT info, e.g., WT 1 info 1546 includes data 1548, terminal ID 1550, sector ID 1552, uplink channel information 1554, downlink channel information 1556, and mode information 1558.

Routines 1518 include communications routines 1522 and base station control routines 1524. Base station control routines 1524 includes a scheduler module 1526 and signaling routines 1528 including a tone subset allocation routine 1530 for strip-symbol periods, other downlink tone allocation hopping routine 1532 for the rest of symbol periods, e.g., non strip-symbol periods, and a beacon routine 1534.

Data 1536 includes data to be transmitted that will be sent to encoder 1514 of transmitter 1504 for encoding prior to transmission to WTs, and received data from WTs that has been processed through decoder 1512 of receiver 1502 following reception. Downlink strip-symbol time information 1540 includes the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone information 1542 includes information including a carrier frequency assigned to the base station 1500, the number and frequency of tones, and the set of tone subsets to be allocated to the strip-symbol periods, and other cell and sector specific values such as slope, slope index and sector type.

Data 1548 may include data that WT1 1600 has received from a peer node, data that WT 1 1600 desires to be transmitted to a peer node, and downlink channel quality report feedback information. Terminal ID 1550 is a base station 1500 assigned ID that identifies WT 1 1600. Sector ID 1552 includes information identifying the sector in which WT1 1600 is operating. Sector ID 1552 can be used, for example, to determine the sector type. Uplink channel information 1554 includes information identifying channel segments that have been allocated by scheduler 1526 for WT1 1600 to use, e.g., uplink traffic channel segments for data, dedicated uplink control channels for requests, power control, timing control, etc. Each uplink channel assigned to WT1 1600 includes one or more logical tones, each logical tone following an uplink hopping sequence. Downlink channel information 1556 includes information identifying channel segments that have been allocated by scheduler 1526 to carry data and/or information to WT1 1600, e.g., downlink traffic channel segments for user data. Each downlink channel assigned to WT1 1600 includes one or more logical tones, each following a downlink hopping sequence. Mode information 1558 includes information identifying the state of operation of WT1 1600, e.g. sleep, hold, on.

Communications routines 1522 control the base station 1500 to perform various communications operations and implement various communications protocols. Base station control routines 1524 are used to control the base station 1500 to perform basic base station functional tasks, e.g., signal generation and reception, scheduling, and to implement the steps of the method of some aspects including transmitting signals to wireless terminals using the tone subset allocation sequences during the strip-symbol periods.

Signaling routine 1528 controls the operation of receiver 1502 with its decoder 1512 and transmitter 1504 with its encoder 1514. The signaling routine 1528 is responsible controlling the generation of transmitted data 1536 and control information. Tone subset allocation routine 1530 constructs the tone subset to be used in a strip-symbol period using the method of the aspect and using data/info 1520 including downlink strip-symbol time info 1540 and sector ID 1552. The downlink tone subset allocation sequences will be different for each sector type in a cell and different for adjacent cells. The WTs 1600 receive the signals in the strip-symbol periods in accordance with the downlink tone subset allocation sequences; the base station 1500 uses the same downlink tone subset allocation sequences in order to generate the transmitted signals. Other downlink tone allocation hopping routine 1532 constructs downlink tone hopping sequences, using information including downlink tone information 1542, and downlink channel information 1556, for the symbol periods other than the strip-symbol periods. The downlink data tone hopping sequences are synchronized across the sectors of a cell. Beacon routine 1534 controls the transmission of a beacon signal, e.g., a signal of relatively high power signal concentrated on one or a few tones, which may be used for synchronization purposes, e.g., to synchronize the frame timing structure of the downlink signal and therefore the tone subset allocation sequence with respect to an ultra-slot boundary.

FIG. 16 illustrates an example wireless terminal (end node) 1600 which can be used as any one of the wireless terminals (end nodes), e.g., EN(1) 1436, of the system 1400 shown in FIG. 14. Wireless terminal 1600 implements the tone subset allocation sequences. The wireless terminal 1600 includes a receiver 1602 including a decoder 1612, a transmitter 1604 including an encoder 1614, a processor 1606, and memory 1608 which are coupled together by a bus 1610 over which the various elements 1602, 1604, 1606, 1608 can interchange data and information. An antenna 1603 used for receiving signals from a base station (and/or a disparate wireless terminal) is coupled to receiver 1602. An antenna 1605 used for transmitting signals, e.g., to a base station (and/or a disparate wireless terminal) is coupled to transmitter 1604.

The processor 1606, e.g., a CPU controls the operation of the wireless terminal 1600 and implements methods by executing routines 1620 and using data/information 1622 in memory 1608.

Data/information 1622 includes user data 1634, user information 1636, and tone subset allocation sequence information 1650. User data 1634 may include data, intended for a peer node, which will be routed to encoder 1614 for encoding prior to transmission by transmitter 1604 to a base station, and data received from the base station which has been processed by the decoder 1612 in receiver 1602. User information 1636 includes uplink channel information 1638, downlink channel information 1640, terminal ID information 1642, base station ID information 1644, sector ID information 1646, and mode information 1648. Uplink channel information 1638 includes information identifying uplink channels segments that have been assigned by a base station for wireless terminal 1600 to use when transmitting to the base station. Uplink channels may include uplink traffic channels, dedicated uplink control channels, e.g., request channels, power control channels and timing control channels. Each uplink channel includes one or more logic tones, each logical tone following an uplink tone hopping sequence. The uplink hopping sequences are different between each sector type of a cell and between adjacent cells. Downlink channel information 1640 includes information identifying downlink channel segments that have been assigned by a base station to WT 1600 for use when the base station is transmitting data/information to WT 1600. Downlink channels may include downlink traffic channels and assignment channels, each downlink channel including one or more logical tone, each logical tone following a downlink hopping sequence, which is synchronized between each sector of the cell.

User info 1636 also includes terminal ID information 1642, which is a base station-assigned identification, base station ID information 1644 which identifies the specific base station that WT has established communications with, and sector ID info 1646 which identifies the specific sector of the cell where WT 1600 is presently located. Base station ID 1644 provides a cell slope value and sector ID info 1646 provides a sector index type; the cell slope value and sector index type may be used to derive tone hopping sequences. Mode information 1648 also included in user info 1636 identifies whether the WT 1600 is in sleep mode, hold mode, or on mode.

Tone subset allocation sequence information 1650 includes downlink strip-symbol time information 1652 and downlink tone information 1654. Downlink strip-symbol time information 1652 include the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone info 1654 includes information including a carrier frequency assigned to the base station, the number and frequency of tones, and the set of tone subsets to be allocated to the strip-symbol periods, and other cell and sector specific values such as slope, slope index and sector type.

Routines 1620 include communications routines 1624 and wireless terminal control routines 1626. Communications routines 1624 control the various communications protocols used by WT 1600. Wireless terminal control routines 1626 controls basic wireless terminal 1600 functionality including the control of the receiver 1602 and transmitter 1604. Wireless terminal control routines 1626 include the signaling routine 1628. The signaling routine 1628 includes a tone subset allocation routine 1630 for the strip-symbol periods and an other downlink tone allocation hopping routine 1632 for the rest of symbol periods, e.g., non strip-symbol periods. Tone subset allocation routine 1630 uses user data/info 1622 including downlink channel information 1640, base station ID info 1644, e.g., slope index and sector type, and downlink tone information 1654 in order to generate the downlink tone subset allocation sequences in accordance with some aspects and process received data transmitted from the base station. Other downlink tone allocation hopping routine 1630 constructs downlink tone hopping sequences, using information including downlink tone information 1654, and downlink channel information 1640, for the symbol periods other than the strip-symbol periods. Tone subset allocation routine 1630, when executed by processor 1606, is used to determine when and on which tones the wireless terminal 1600 is to receive one or more strip-symbol signals from the base station 1400. The uplink tone allocation hopping routine 1630 uses a tone subset allocation function, along with information received from the base station, to determine the tones in which it should transmit on.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

When the embodiments are implemented in program code or code segments, it should be appreciated that a code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc. Additionally, in some aspects, the steps and/or actions of a method or algorithm can reside as one or any combination or set of codes and/or instructions on a machine readable medium and/or computer readable medium, which can be incorporated into a computer program product.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. A method that facilitates multicarrier channel quality indicator (CQI) feedback from a wireless terminal comprising:
employing a processor to execute computer executable instructions stored on a computer readable storage medium to implement a series of steps including:
communicating with a base station via a plurality of carriers;
receiving a configuration dataset from the base station, the configuration dataset identifying a subset of carriers included in the plurality of carriers;
identifying a reference carrier within the subset of carriers; and
reporting a reference CQI value and at least one differential CQI value to the base station, the reference CQI value corresponding to the reference carrier, the at least one differential CQI value derived from the reference CQI value.

2. The method of claim 1, the identifying further comprising ascertaining a CQI value for each of the subset of carriers, the reference carrier identified as a function of comparing the CQI value for each of the subset of carriers.

3. The method of claim 2, the identifying further comprising ascertaining a highest CQI value amongst the subset of carriers, the reference carrier identified based on the highest CQI value amongst the subset of carriers.

4. The method of claim 3, wherein the subset of carriers includes a plurality of non-reference carriers different than the reference carrier, each of the plurality of non-reference carriers having a corresponding differential CQI value relative to the highest CQI value amongst the subset of carriers, the reporting further comprising reporting the corresponding differential CQI value for each of the plurality of non-reference carriers by cycling through each of the plurality of non-reference carriers in different reporting instances.

5. The method of claim 3, the reporting further comprising identifying the reference carrier to the base station in each of a plurality of reporting instances.

6. The method of claim 1 further comprising ascertaining a plurality of sub-band CQI values for at least one of the subset of carriers by defining a plurality of bandwidth parts for the at least one of the subset of carriers, wherein the reference CQI value is a first of the plurality of sub-band CQI values corresponding to a first of the plurality of bandwidth parts, and wherein the at least one differential CQI value is derived by comparing a second of the plurality of sub-band CQI values to the first of the plurality of sub-band CQI values, the second of the plurality of sub-band CQI values corresponding to a second of the plurality of bandwidth parts.

7. The method of claim 6 further comprising ascertaining a number of bandwidth parts for each of the subset of carriers, wherein a maximum among the number of bandwidth parts is adoptable as a configuration parameter.

8. The method of claim 6, the reporting further comprising reporting the reference CQI value and the at least one differential CQI value by cycling through each of the plurality of bandwidth parts in different reporting instances.

9. The method of claim 2, the CQI value for each of the subset of carriers respectively corresponding to a wideband CQI value for each of the subset of carriers, the identifying further comprising ascertaining a highest wideband CQI value amongst the subset of carriers, wherein the reference carrier is identified based on the highest wideband CQI value amongst the subset of carriers.

10. The method of claim 9, wherein the subset of carriers includes a plurality of non-reference carriers different than the reference carrier, each of the plurality of non-reference carriers having a corresponding differential CQI value relative to the highest wideband CQI value amongst the subset of carriers, the reporting further comprising reporting the corresponding differential CQI value for each of the plurality of non-reference carriers by cycling through each of the plurality of non-reference carriers in different reporting instances.

11. The method of claim 2, wherein the reference CQI value is a first wideband CQI value for the reference carrier at a first reporting instance, and wherein the at least one differential CQI value is a second wideband CQI value for the reference carrier at a second reporting instance.

12. The method of claim 1 further comprising ascertaining a plurality of sub-band CQI values for each of the subset of carriers by defining a plurality of bandwidth parts for each of the subset of carriers, wherein the reference CQI value is a wideband CQI value for the reference carrier, and wherein each of the plurality of sub-band CQI values for each of the subset of carriers has a corresponding differential CQI value derived from the wideband CQI value for the reference carrier.

13. The method of claim 12, the reporting further comprising reporting the corresponding differential CQI value for each of the plurality of sub-band CQI values for each of the subset of carriers by cycling through each of the plurality of bandwidth parts for each of the subset of carriers in different reporting instances.

14. The method of claim 1, the configuration dataset further including data identifying a particular carrier, the identifying further comprising identifying the reference carrier as the particular carrier identified in the configuration dataset.

15. The method of claim 1, the configuration dataset further including data identifying a rotation of reference carriers, the identifying further comprising rotating the reference carrier as a function of the rotation.

16. The method of claim 15, the rotation identifying a first reference carrier for reporting a first set of reporting instances, the subset of carriers includes a plurality of non-reference carriers different than the first reference carrier, wherein each of the plurality of non-reference carriers has a corresponding differential CQI value respectively derived from a first reference CQI value corresponding to the first reference carrier, and wherein the reporting further comprises cycling over the subset of carriers, the reporting further comprising reporting the corresponding differential CQI value for each of the plurality of non-reference carriers by cycling through each of the plurality of non-reference carriers in different reporting instances of the first set of reporting instances.

17. The method of claim 1, the reporting further comprising reporting over a plurality of reporting instances, wherein feedback information corresponding to at least two different carriers within the subset of carriers is reported during at least one of the plurality of reporting instances.

18. The method of claim 1, the reporting further comprising reporting over a plurality of reporting instances, wherein feedback information corresponding to at least two different sub-bands is reported during at least one of the plurality of reporting instances.

19. The method of claim 1, the configuration dataset further including data identifying a desired reporting sequence, the reporting further comprising reporting the reference CQI value and the at least one differential CQI value as a function of the desired reporting sequence.

20. The method of claim 1, the configuration dataset further including data identifying a desired CQI granularity, the reporting further comprising reporting the reference CQI value and the at least one differential CQI value as a function of the desired CQI granularity.

21. The method of claim 20, the configuration dataset including an identification of a desired bit length for at least one of the reference CQI value or the at least one differential CQI value, the reporting further comprising reporting at least one of the reference CQI value or the at least one differential CQI value based on the desired bit length.

22. The method of claim 1, the reporting further comprising reporting at least one of a rank indicator (RI) or a pre-coding matrix indicator (PMI).

23. An apparatus for facilitating multicarrier channel quality indicator (CQI) feedback from a wireless terminal, the apparatus comprising:
a processor configured to execute computer executable components stored in memory, the components including:
a receiving component configured to receive a signal from a base station via a plurality of carriers;
a monitoring component configured to monitor a subset of carriers included in the plurality of carriers, the subset of carriers identified as a function of a configuration dataset received from the base station;
a reference identification component configured to identify a reference carrier within the subset of carriers;
a CQI processing component configured to ascertain a reference CQI value and at least one differential CQI value, the reference CQI value corresponding to the reference carrier, the at least one differential CQI value derived from the reference CQI value; and
a transmitting component configured to report the reference CQI value and the at least one differential CQI value to the base station.

24. The apparatus of claim 23, the reference identification component further configured to ascertain a CQI value for each of the subset of carriers and to identify the reference carrier by comparing the CQI value for each of the subset of carriers.

25. The apparatus of claim 24, the reference identification component further configured to identify a carrier having a highest CQI value amongst the subset of carriers and to identify the reference carrier as the carrier having the highest CQI value amongst the subset of carriers.

26. The apparatus of claim 25, wherein the subset of carriers includes a plurality of non-reference carriers different than the reference carrier, each of the plurality of non-reference carriers having a corresponding differential CQI value relative to the highest CQI value amongst the subset of carriers, the transmitting component configured to report the corresponding differential CQI value for each of the plurality of non-reference carriers by cycling through each of the plurality of non-reference carriers in different reporting instances.

27. The apparatus of claim 25, the transmitting component configured to identify the reference carrier to the base station in each of a plurality of reporting instances.

28. The apparatus of claim 23, the CQI processing component configured to ascertain a plurality of sub-band CQI values for at least one of the subset of carriers by defining a plurality of bandwidth parts for the at least one of the subset of carriers, wherein the reference CQI value is a first of the plurality of sub-band CQI values corresponding to a first of the plurality of bandwidth parts, and wherein the at least one differential CQI value is derived by comparing a second of the plurality of sub-band CQI values to the first of the plurality of sub-band CQI values, the second of the plurality of sub-band CQI values corresponding to a second of the plurality of bandwidth parts.

29. The apparatus of claim 28, the CQI processing component configured to ascertain a number of bandwidth parts for each of the subset of carriers, wherein a maximum among the number of bandwidth parts is adoptable as a configuration parameter.

30. The apparatus of claim 28, the transmitting component configured to report the reference CQI value and the at least one differential CQI value by cycling through each of the plurality of bandwidth parts in different reporting instances.

31. The apparatus of claim 24, the CQI value for each of the subset of carriers respectively corresponding to a wideband CQI value for each of the subset of carriers, the CQI processing component configured to ascertain a highest wideband CQI value amongst the subset of carriers, wherein the reference identification component is configured to identify the reference carrier based on the highest wideband CQI value amongst the subset of carriers.

32. The apparatus of claim 31, wherein the subset of carriers includes a plurality of non-reference carriers different than the reference carrier, each of the plurality of non-reference carriers having a corresponding differential CQI value relative to the highest wideband CQI value amongst the subset of carriers, the transmitting component configured to report the corresponding differential CQI value for each of the plurality of non-reference carriers by cycling through each of the plurality of non-reference carriers in different reporting instances.

33. The apparatus of claim 24, wherein the reference CQI value is a first wideband CQI value for the reference carrier at a first reporting instance, and wherein the at least one differential CQI value is a second wideband CQI value for the reference carrier at a second reporting instance.

34. The apparatus of claim 23, the CQI processing component configured to ascertain a plurality of sub-band CQI values for each of the subset of carriers by defining a plurality of bandwidth parts for each of the subset of carriers, wherein the reference CQI value is a wideband CQI value for the reference carrier, and wherein each of the plurality of sub-band CQI values for each of the subset of carriers has a corresponding differential CQI value derived from the wideband CQI value for the reference carrier.

35. The apparatus of claim 34, the transmitting component configured to report the corresponding differential CQI value for each of the plurality of sub-band CQI values for each of the subset of carriers by cycling through each of the plurality of bandwidth parts for each of the subset of carriers in different reporting instances.

36. The apparatus of claim 23, the configuration dataset further including data identifying a particular carrier, the reference identification component further configured to identify the reference carrier as the particular carrier identified in the configuration dataset.

37. The apparatus of claim 23, the configuration dataset further including data identifying a rotation of reference carriers, the reference identification component further configured to identify the reference carrier based on the rotation.

38. The apparatus of claim 37, the rotation identifying a first reference carrier for reporting a first set of reporting instances, the subset of carriers includes a plurality of non-reference carriers different than the first reference carrier, wherein each of the plurality of non-reference carriers has a corresponding differential CQI value respectively derived from a first reference CQI value corresponding to the first reference carrier, and wherein the reporting further comprises cycling over the subset of carriers, the transmitting component configured to report the corresponding differential CQI value for each of the plurality of non-reference carriers by cycling through each of the plurality of non-reference carriers in different reporting instances of the first set of reporting instances.

39. The apparatus of claim 23, the transmitting component configured to report over a plurality of reporting instances, wherein feedback information corresponding to at least two different carriers within the subset of carriers is reported during at least one of the plurality of reporting instances.

40. The apparatus of claim 23, the transmitting component configured to report over a plurality of reporting instances, wherein feedback information corresponding to at least two different sub-bands is reported during at least one of the plurality of reporting instances.

41. The apparatus of claim 23, the configuration dataset further including data identifying a desired reporting sequence, the transmitting component further configured to transmit the reference CQI value and the at least one differential CQI value based on the desired reporting sequence.

42. The apparatus of claim 23, the configuration dataset further including data identifying a desired CQI granularity, the CQI processing component configured to ascertain the reference CQI value and the at least one differential CQI value based on the desired CQI granularity.

43. The apparatus of claim 42, the configuration dataset including an identification of a desired bit length for at least one of the reference CQI value or the at least one differential CQI value, the CQI processing component configured to ascertain at least one of the reference CQI value or the at least one differential CQI value based on the desired bit length.

44. The apparatus of claim 23, the transmitting component configured to report at least one of a rank indicator (RI) or a pre-coding matrix indicator (PMI).

45. A computer program product for facilitating multicarrier channel quality indicator (CQI) feedback from a wireless terminal, comprising:
a computer-readable storage medium comprising code for:
communicating with a base station via a plurality of carriers;
receiving a configuration dataset from the base station, the configuration dataset identifying a subset of carriers included in the plurality of carriers;
identifying a reference carrier within the subset of carriers; and
reporting a reference CQI value and at least one differential CQI value to the base station, the reference CQI value corresponding to the reference carrier, the at least one differential CQI value derived from the reference CQI value.

46. An apparatus for facilitating multicarrier channel quality indicator (CQI) feedback from a wireless terminal, comprising:
means for communicating with a base station via a plurality of carriers;
means for receiving a configuration dataset from the base station, the configuration dataset identifying a subset of carriers included in the plurality of carriers;
means for identifying a reference carrier within the subset of carriers; and
means for reporting a reference CQI value and at least one differential CQI value to the base station, the reference CQI value corresponding to the reference carrier, the at least one differential CQI value derived from the reference CQI value.

47. A method that facilitates multicarrier channel quality indicator (CQI) feedback from a base station, the method comprising:
employing a processor to execute computer executable instructions stored on a computer readable storage medium to implement a series of steps including:
communicating with a wireless terminal via a plurality of carriers;
generating a configuration dataset, the configuration dataset identifying a subset of carriers included in the plurality of carriers;
transmitting the configuration dataset to the wireless terminal; and
processing CQI data received from the wireless terminal, the CQI data including a reference CQI value and at least one differential CQI value, the reference CQI value corresponding to a reference carrier for the subset of carriers, the at least one differential CQI value derived from the reference CQI value.

48. The method of claim 47, the generating further comprising generating the configuration dataset to direct the wireless terminal to ascertain a CQI value for each of the subset of carriers and to identify the reference carrier as a function of comparing the CQI value for each of the subset of carriers.

49. The method of claim 48, the generating further comprising generating the configuration dataset to direct the wireless terminal to identify a carrier having a highest CQI value amongst the subset of carriers and to identify the reference carrier as the carrier having the highest CQI value amongst the subset of carriers.

50. The method of claim 47, the generating further comprising generating the configuration dataset to direct the wireless terminal to identify the reference carrier as a particular carrier identified by the configuration dataset.

51. The method of claim 47, the generating further comprising generating the configuration dataset to direct the wireless terminal to identify the reference carrier as a function of a rotation of reference carriers identified by the configuration dataset.

52. The method of claim 47, the generating further comprising generating the configuration dataset to direct the wireless terminal to report the reference CQI value and the at least one differential CQI value as a function of a desired reporting sequence identified by the configuration dataset.

53. The method of claim 47, the generating further comprising generating the configuration dataset to direct the wireless terminal to report the reference CQI value and the at least one differential CQI value as a function of a desired CQI granularity identified by the configuration dataset.

54. The method of claim 53, the generating further comprising generating the configuration dataset to direct the wireless terminal to report at least one of the reference CQI value or the at least one differential CQI value based on a desired bit length for at least one of the reference CQI value or the at least one differential CQI value, the desired bit length identified by the configuration dataset.

55. An apparatus for facilitating multicarrier channel quality indicator (CQI) feedback from a base station, the apparatus comprising:
a processor configured to execute computer executable components stored in memory, the components including:
a communication component configured to facilitate a communication with a wireless terminal via a plurality of carriers, the communication including a transmission of a configuration dataset to the wireless terminal;
a generation component configured to generate the configuration dataset, the configuration dataset identifying a subset of carriers included in the plurality of carriers; and
a CQI processing component configured to process CQI data received from the wireless terminal, the CQI data including a reference CQI value and at least one differential CQI value, the reference CQI value corresponding to a reference carrier for the subset of carriers, the at least one differential CQI value derived from the reference CQI value.

56. The apparatus of claim 55, the generation component further configured to generate the configuration dataset to direct the wireless terminal to ascertain a CQI value for each of the subset of carriers and to identify the reference carrier as a function of comparing the CQI value for each of the subset of carriers.

57. The apparatus of claim 56, the generation component further configured to generate the configuration dataset to direct the wireless terminal to identify a carrier having a highest CQI value amongst the subset of carriers and to identify the reference carrier as the carrier having the highest CQI value amongst the subset of carriers.

58. The apparatus of claim 55, the generation component further configured to generate the configuration dataset to direct the wireless terminal to identify the reference carrier as a particular carrier identified by the configuration dataset.

59. The apparatus of claim 55, the generation component further configured to generate the configuration dataset to direct the wireless terminal to identify the reference carrier as a function of a rotation of reference carriers identified by the configuration dataset.

60. The apparatus of claim 55, the generation component further configured to generate the configuration dataset to direct the wireless terminal to report the reference CQI value and the at least one differential CQI value as a function of a desired reporting sequence identified by the configuration dataset.

61. The apparatus of claim 55, the generation component further configured to generate the configuration dataset to direct the wireless terminal to report the reference CQI value and the at least one differential CQI value as a function of a desired CQI granularity identified by the configuration dataset.

62. The apparatus of claim 61, the generation component further configured to generate the configuration dataset to direct the wireless terminal to report at least one of the reference CQI value or the at least one differential CQI value based on a desired bit length for at least one of the reference CQI value or the at least one differential CQI value, the desired bit length identified by the configuration dataset.

63. A computer program product for facilitating multicarrier channel quality indicator (CQI) feedback from a base station, comprising:
a computer-readable storage medium comprising code for:
communicating with a wireless terminal via a plurality of carriers;
generating a configuration dataset, the configuration dataset identifying a subset of carriers included in the plurality of carriers;
transmitting the configuration dataset to the wireless terminal; and
processing CQI data received from the wireless terminal, the CQI data including a reference CQI value and at least one differential CQI value, the reference CQI value corresponding to a reference carrier for the subset of carriers, the at least one differential CQI value derived from the reference CQI value.

64. An apparatus for facilitating multicarrier channel quality indicator (CQI) feedback from a base station, comprising:
means for communicating with a wireless terminal via a plurality of carriers;
means for generating a configuration dataset, the configuration dataset identifying a subset of carriers included in the plurality of carriers;
means for transmitting the configuration dataset to the wireless terminal; and
means for processing a CQI data received from the wireless terminal, the CQI data including a reference CQI value and at least one differential CQI value, the reference CQI value corresponding to a reference carrier for the subset of carriers, the at least one differential CQI value derived from the reference CQI value.
